(19) United States
(12) Patent Application Publication
(10) Pub. No.: US 2026/0337318 A1
(43) Pub. Date: Oct. 29, 2026

(54) METHOD FOR PRODUCING POLYMER

(71) Applicant: MARUZEN PETROCHEMICAL CO., LTD., Tokyo (JP)

(72) Inventors: Masataka NOJIMA, Ichihara-Shi (JP); Momoka TAMURA, Ichihara-Shi (JP)

(73) Assignee: MARUZEN PETROCHEMICAL CO., LTD., Tokyo (JP)

(21) Appl. No.: 19/158,501

(22) PCT Filed: Mar. 14, 2024
(86) PCT No.: PCT/JP2024/009921

§ 371 Date: Aug. 21, 2025

(30) Foreign Application Priority Data
Mar. 17, 2023 (JP) 2023-043432
Jul. 11, 2023 (JP) 2023-114005

(51) Int. Cl. C08F 220/18; B01D 15/36; B01D 37/02; B01J 39/16

(52) U.S. Cl. CPC C08F 220/1804; B01D 15/362; B01D 37/025; B01J 39/16; B01D 2201/182

(57) ABSTRACT

To provide a method for producing a polymer for resists, in which metal elution from a depth filter is suppressed in a demetallization treatment of a polymer for resists, comprising an acidic group, and the amount of metallic impurities is extremely small. The method for producing a polymer according to the present invention includes a step of preparing a polymer, and a step of passing a polymer solution in which the polymer is dissolved in an organic solvent, through a depth filter, wherein the depth filter has been washed with a solution containing an acid having a plurality of carboxyl groups.

### BACKGROUND OF THE INVENTION

### Field of the Invention

The present invention relates to a method for removing metallic impurities included in a polymer for resists.

### Background Art

Compositions for photoresists, with, as base polymers, oxystyrene-based polymers including various novolac-based polymers, acrylic polymers, and hydroxystyrene, are used in photolithography used for semiconductor manufacturing. For example, thin films of compositions for photolithography, such as photoresists and antireflection films, are formed on substrates such as silicon wafers, thereafter irradiated with excimer laser light or the like via masks where semiconductor device circuit patterns are drawn, and developed to provide photoresist patterns, and the photoresist patterns are used as protective films to perform etching treatment of substrates, thereby forming fine patterns corresponding semiconductor circuits, on substrate surfaces. According to an increase in degree of integration, formation of finer patterns is demanded, and lithography techniques with KrF excimer laser light (wavelength 248 nm) and ArF excimer laser light (wavelength 193 nm) are currently used for mass production. There are also increasingly developed and researched lithography techniques with F2 excimer laser light (wavelength 157 nm) shorter in wavelength, EUV (extreme-ultraviolet rays) and X-rays shorter in wavelength than such excimer laser, and electron beams.

As semiconductor circuits are progressively finer according to an increase in the degree of integration, there is also further severe demand for a decrease in the amount of impurities included in polymers to be used in photolithography. In particular, metallic impurities have various adverse effects on semiconductor manufacturing and, therefore, need to be removed as much as possible. For example, if metallic impurities are included in polymers for chemically amplified resists, acidic substances generated from acid generators during exposure are trapped by metal components, polymers as base material components of resists are not sufficiently dissolved, and desired patterns cannot be formed. In addition, if not only metallic impurities included in polymers for resists, but also those included in polymers for photolithography, such as polymers for topcoats or polymers for antireflection films, finally remain on semiconductor substrate surfaces, electric characteristics of semiconductors are impaired to cause deterioration in product yield.

There are known, as methods for removing metallic impurities in polymers, a method for contacting a solution in which a polymer is dissolved in an organic solvent, with a strong acid cation-exchange resin (Patent Literature 1), a treatment method with a filter including a cation charge control agent generating zeta potential or a filter including a cation exchanger and/or a chelate former (Patent Literature 2 and 3), and a method for extracting a polymer with water and an organic solvent (washing with water) (Patent Literature 4).

In particular, methods with filters are simple, and filters for electronic materials, in which metals can be removed at high levels, are also commercially available.

Such filters have the ability to trap metal ions at sub-ppb to ppb levels in liquids, and metal elution from filters themselves is also suppressed by special treatment and production methods. Pre-treatments before use of filters are described in catalogs of products, and are often performed by methods including passing a predetermined amount of pure water therethrough for washing and then performing replacement with solvents of solutions to be passed in the relevant use.

### CITATION LIST

### Patent Literature

Patent Literature 1: JP-A No. H5-148308
Patent Literature 2: JP-A No. H8-165313
Patent Literature 3: JP-A No. H10-237125
Patent Literature 4: WO2003/082933

### SUMMARY OF THE INVENTION

### Technical Problem

However, even if a filter for an electronic material application is adopted and a pre-treatment recommended by a manufacturer is performed as described above, metal elution from such a filter may be observed depending on the type of a polymer to be passed, and has been problematic for production of a polymer for resists in which removal of metallic impurities at high levels is demanded.

### Solution to Problem

The present inventors have made intensive studies in order to solve the above problems, as a result, have found that the above problems can be solved by using a depth filter washed with a solution containing an acid having a plurality of carboxyl groups, as a depth filter for passing a solution in which a polymer is dissolved in an organic solvent, and thus have completed the present invention.

Specifically, the present invention provides the following aspects.
[1] A method for producing a polymer, the method comprising:
   a step of preparing a polymer; and
   a step of passing a polymer solution in which the polymer is dissolved in an organic solvent, through a depth filter, wherein
   the depth filter has been washed with a solution containing an acid having a plurality of carboxyl groups.
[2] The method for producing a polymer according to [1], wherein the polymer comprises a structural unit having an acidic group.
[3] The method for producing a polymer according to [2], wherein the acidic group comprises at least one selected from the group consisting of a phenolic hydroxyl group, a carboxyl group, and a sulfo group.
[4] The method for producing a polymer according to any of [1] to [3], wherein the acid having a plurality of carboxyl groups is a divalent to tetravalent carboxylic acid.
[5] The method for producing a polymer according to any of [1] to [3], wherein the acid having a plurality of carboxyl groups comprises at least one selected from the group consisting of oxalic acid, malonic acid, succinic acid, citric acid, 1,2,3,4-butanetetracarboxylic acid and ethylenediaminetetraacetic acid.
[6] The method for producing a polymer according to any of [1] to [5], wherein the depth filter comprises at least one selected from the group consisting of diatomaceous earth, magnesia, pearlite, talc, colloidal silica, activated carbon, zeolite, clay, and cellulose.
[7] The method for producing a polymer according to any of [1] to [5], wherein the depth filter comprises at least one selected from the group consisting of diatomaceous earth, magnesia, pearlite, talc, colloidal silica, activated carbon, zeolite, clay, and cellulose, and a cation charge control agent that generates zeta potential and/or an ion exchanger excluding a Na-type ion exchanger.
[8] The method for producing a polymer according to any of [1] to [3], wherein
   the acid having a plurality of carboxyl groups is a divalent to tetravalent carboxylic acid, and
   the depth filter comprises at least one selected from the group consisting of diatomaceous earth, magnesia, pearlite, talc, colloidal silica, activated carbon, zeolite, clay, and cellulose.
[9] The method for producing a polymer according to any of [1] to [3], wherein
   the acid having a plurality of carboxyl groups is a divalent to tetravalent carboxylic acid, and
   the depth filter comprises at least one selected from the group consisting of diatomaceous earth, magnesia, pearlite, talc, colloidal silica, activated carbon, zeolite, clay, and cellulose, and a cation charge control agent that generates zeta potential and/or an ion exchanger excluding a Na-type ion exchanger.
[10] A method for producing a polymer, the method comprising:
   a step of preparing a polymer;
   a step of installing a depth filter in filtration equipment, thereafter washing the depth filter with a solution containing an acid having a plurality of carboxyl groups, and subsequently washing the depth filter with water and/or an organic solvent; and
   a step of passing a polymer solution in which the polymer is dissolved in an organic solvent, through the washed depth filter.
[11] The method for producing a polymer according to [10], wherein the polymer comprises a structural unit having an acidic group.
[12] The method for producing a polymer according to [11], wherein the acidic group comprises at least one selected from the group consisting of a phenolic hydroxyl group, a carboxyl group, and a sulfo group.
[13] The method for producing a polymer according to any of [10] to [12], wherein the acid having a plurality of carboxyl groups is a divalent to tetravalent carboxylic acid.
[14] The method for producing a polymer according to any of [10] to [12], wherein
the acid having a plurality of carboxyl groups is a divalent to tetravalent carboxylic acid, and
the depth filter comprises at least one selected from the group consisting of diatomaceous earth, magnesia, pearlite, talc, colloidal silica, activated carbon, zeolite, clay, and cellulose.
[15] The method for producing a polymer according to any of [10] to [12], wherein
the acid having a plurality of carboxyl groups is a divalent to tetravalent carboxylic acid, and
the depth filter comprises at least one selected from the group consisting of diatomaceous earth, magnesia, pearlite, talc, colloidal silica, activated carbon, zeolite, clay, and cellulose, and a cation charge control agent that generates zeta potential and/or an ion exchanger excluding a Na-type ion exchanger.

### Advantageous Effect of Invention

According to the present invention, it is possible to produce a polymer for resists suitable for state-of-the-art lithography such as EUV lithography, in which metal elution from a depth filter is suppressed in a demetallization treatment of a polymer for resists, comprising an acidic group, and the amount of metallic impurities is extremely small.

### DETAILED DESCRIPTION OF THE INVENTION

### [Method for Producing Polymer]

The method for producing a polymer of the present invention includes a step of preparing a polymer, and a step of passing a solution in which the polymer is dissolved in an organic solvent (hereinafter, sometimes referred to as “polymer solution”), through a depth filter. The method for producing a polymer of the present invention may further include a step of washing a depth filter, before the passing step.

### [a Step of Preparing a Polymer]

The polymer prepared in the present invention can be any polymer without any particular limitations as long as it is a conventionally known polymer for resists, and is particularly preferably a polymer having a structure comprising an acidic group. In a case where such a polymer comprising an acidic group is filtered with a depth filter, any undesired metal component may be eluted from the depth filter to contaminate the polymer. The present invention can prevent such contamination.

Examples of the acidic group include a phenolic hydroxyl group, a carboxyl group, and a sulfo group. Among these, in particular, a polymer having a structure comprising a phenolic hydroxyl group is suitably used in a resist application.

The method for forming the polymer by polymerization and the method for purifying the polymer are not particularly limited, and can be carried out by any methods similar to the conventionally known formation method and purification method of a polymer for resists.

### [a Step of Passing a Polymer Solution Through a Depth Filter]

In the present invention, a step of filtering the polymer solution by a depth filter in order to remove metallic impurities in the polymer is included.

Examples of the filter medium of the depth filter used in the present invention include fiber components such as cotton, pulp, a cellulose fiber, a cellulose acetate fiber, a polyacrylonitrile fiber, a nylon fiber, a rayon fiber, a polyester fiber, and a polyvinyl chloride fiber; and particle components such as diatomaceous earth, pearlite, magnesia, talc, activated carbon, zeolite, and colloidal silica. Among these, examples thereof particularly in an application for treating an electronic material such as a resist preferably include a cellulose fiber, a cellulose acetate fiber, a polyacrylonitrile fiber, a nylon fiber, a rayon fiber, a polyester fiber, a polyvinyl chloride fiber, diatomaceous earth, pearlite, zeolite, and colloidal silica.

The depth filter may include a cation-exchange resin, an anion-exchange resin, a chelate resin, or any mixture thereof. The ion-exchange resin or the chelate resin included, when being in a state of having an alkali metal counterion, for example, when being a sodium ion type resin, may be converted into a proton type resin by an acid treatment in advance. This acid treatment is a different operation from the washing with a solution containing an acid having a plurality of carboxyl groups in the present invention, and the acid used here is suitably hydrochloric acid, sulfuric acid, or the like. This operation is not needed if the ion-exchange resin or the chelate resin included is originally a proton type resin. After such acid washing, the filter can be dehydrated by further washing with an aqueous miscible organic solvent such as ethyl lactate or acetone or/and any other organic solvent.

The depth filter may include a cation charge control agent such as a polyamide polyamine epichlorohydrin cationic resin or a melamine-formaldehyde cationic resin. The cation charge control agent imparts a cation charge to the filter, to generate zeta potential between the cation charge and a substance charged in the course of filtration of impurities in a liquid passing through the filter, and is effective for removal of fine foreign substances and/or metallic impurities.

The nominal pore size of the depth filter is preferably 1.0 μm or less, more preferably 0.9 μm or less, further preferably 0.7 μm or less, still more preferably 0.5 μm or less, and may be 0.01 μm or more, may be 0.02 μm or more, or may be 0.05 μm or more. The nominal pore size mentioned herein is a nominal pore size indicating separation performance of the filter, and is a pore size determined by a testing method prescribed by the manufacturer of the filter, such as a bubble point test, a mercury intrusion method test, or a standard particle trapping test. In a case where a commercially available product is used, a value described in the catalog data from the manufacturer is adopted.

Examples of a commercially available depth filter particularly for an electronic material application include Zeta Plus 40Q series, Zeta Plus GN series, and Zeta Plus EC series from 3M.

### [a Step of Washing a Depth Filter]

In the present invention, a depth filter washed with a solution containing an acid having a plurality of carboxyl groups (hereinafter, sometimes referred to as “washing solution”) is used.

A step of washing the depth filter with the washing solution, before the step of passing the polymer solution, may be included. Specifically, it is preferable to install a depth filter in filtration equipment and thereafter wash the depth filter with the washing solution and subsequently with water and/or an organic solvent.

In the present invention, even when a depth filter with a filter medium that can include a transition metal is adopted, metal elution from such a depth filter can be suppressed by washing in advance. Examples of the filter medium that can include a transition metal include diatomaceous earth, magnesia, pearlite, talc, colloidal silica, activated carbon, zeolite, clay, and cellulose.

The number of carboxyl groups in the acid contained in the washing solution is not restricted as long as it is 2 or more, and is preferably 2 to 4. The acid may also be a hydroxycarboxylic acid, which has a hydroxy group in combination.

Specific examples of the carboxylic acid having two carboxy groups include oxalic acid, malonic acid, succinic acid, glutaric acid, malic acid, tartaric acid, maleic acid, citraconic acid, and itaconic acid. Among these, oxalic acid, malonic acid, and succinic acid are preferred, and oxalic acid is particularly preferred.

Specific examples of the carboxylic acid having three carboxy groups include citric acid, isocitric acid, and tricarballylic acid. Among these, citric acid is preferred.

Specific examples of the carboxylic acid having four carboxy groups include 1,2,3,4-butanetetracarboxylic acid and ethylenediaminetetraacetic acid. Among these, 1,2,3,4-butanetetracarboxylic acid is preferred.

The depth filter is also preferably washed with pure water or any other solvent before and/or after washing with the washing solution. In particular, it is preferable after acid washing to allow such pure water or any other solvent to sufficiently flow, and thus remove the acid in the depth filter. It is preferable immediately before passing the polymer solution to replace the inside of the filter with a solvent which is the same as or compatible with the solvent of the polymer solution.

In order to remove any insoluble component and metals in the polymer, further filtration with a membrane filter, a hollow-fiber membrane filter, a pleated filter, or the like other than the depth filter may also be carried out. Examples of such a filter can include polyethylene filters such as Microgard and Optimizer D manufactured by Nihon Entegris G.K., nylon filters such as Ultipleat P-nylon 66 and Ultipor N66 manufactured by Nihon Pall Manufacturing Ltd., PhotoSHIELD and Electropor IIEF manufactured by 3M, and polyethylene fluoride filters such as Pemflon manufactured by Nihon Pall Manufacturing Ltd. Such a filter is also preferably further washed before use, by a method recommended by the manufacturer, commonly with an aqueous miscible organic solvent or/and any other organic solvent (preferably the same solvent as that of a solution to be treated) subsequent to washing with pure water.

### EXAMPLES

Hereinafter, modes of the present invention are described in detail with reference to Examples, but the present invention is not limited to these Examples at all. Herein, “part(s)” in the following Examples is on a mass basis, unless particularly noted.

### [Analysis of Metal in Polymer]

The metal content in a polymer synthesized as described below was measured by ICP mass spectrometry.
ICP mass spectroscope: Agilent™ 8900 cs manufactured by Agilent Technologies

### [Depth Filter]

While depth filters used in Examples were each a clean filter sold for an application of metal removal from an electronic material such as a photoresist, the difference between lots was found and thus filters according to a plurality of lots were prepared and respectively defined as lot A to lot D.
Zeta Plus™ 020GN (nominal pore size 0.2 μm, 90 mmφ) manufactured by 3M, lot A
Zeta Plus™ 020GN (nominal pore size 0.2 μm, 90 mmφ) manufactured by 3M, lot B
Zeta Plus™ 40QSH (nominal pore size 0.2 to 0.5 μm, 90 mmφ) manufactured by 3M, lot C
Zeta Plus™ 40QSH (nominal pore size 0.2 to 0.5 μm, 90 mm) manufactured by 3M, lot D

### Example 1

### (Production of Polymer)

A p-hydroxystyrene composition (p-hydroxystyrene 25% by mass, p-ethylphenol 41% by mass, methanol 23% by mass, water 11%) obtained by dehydrogenating p-ethylphenol, and tert-butyl acrylate were dissolved in methanol so that the molar ratio of the monomers was 66:34, and AIBN was added as a polymerization initiator thereto, to prepare a monomer solution.

A reaction container equipped with a stirrer, a condenser, and a thermometer was charged with one-quarter of the monomer solution, the atmosphere was a nitrogen atmosphere, and the temperature was raised to 80 °C under stirring. The remaining three-quarters of the monomer solution was dropped and supplied thereto at a constant rate over 3 hours, thereafter a polymerization reaction was continued for additional one hour, and the resultant was then cooled to room temperature.

The polymer solution was subjected to precipitation and purification by a known method with toluene as a poor solvent and acetone as a good solvent, and impurities included in the polymer, for example, the polymerization solvent and the unreacted monomers, were removed. Properties of the resulting polymer included PHS:TBA=66:34, a weight average molecular weight (Mw) of 20,000, and a molecular weight distribution (Mw/Mn) of 2.5. Thereafter, the polymer was dissolved again in acetone, to prepare the concentration of the polymer solution to 20% by mass.

### (Washing Depth Filter)

A depth filter manufactured by 3M, Zeta Plus 020GN (90 mmφ) lot A, was mounted to a filter housing, pure water was sent by a pump to fill the housing, and the resultant was left to still stand for 30 minutes as it was. Thereafter, 85 g of an aqueous 3% by mass oxalic acid solution and subsequently 150 g of acetone were passed to wash the filter.

A depth filter manufactured by 3M, Zeta Plus 40QSH (90 mm) lot C, was also washed by the same procedure as in 020GN.

### (Passing Polymer Solution Through Depth Filter)

Two hundred g of a polymer solution having a concentration of 20% by mass was subjected to recirculation filtering five times with the 020GN filter washed, and thereafter filtered once with the 40QSH filter washed.

The metal content in the polymer was analyzed at each stage before a filter treatment, after a 020GN filter treatment, and after a 40QSH filter treatment, and the results were shown in Table 1.

### Comparative Example 1

The 020 filter and the 40QSH filter were pre-washed in the same manner as in Example 1 except that the aqueous 3% by mass oxalic acid solution was changed to pure water in washing the filters. Two hundred g of the same polymer solution having a concentration of 20% by mass as that of Example 1 was subjected to recirculation filtering five times with the 020GN filter washed, and thereafter filtered once with the 40QSH filter washed.

The metal content in the polymer was analyzed at each stage after a 020GN filter treatment and after a 40QSH filter treatment, and the results were shown in Table 1.

TABLE 1

| | | Filter | Metal content (resin weight basis; ppb) | | | | | | | |
|---|---|---|---|---|---|---|---|---|---|---|
| | | washing | Na | Mg | K | Ca | Cr | Fe | Ni | V |
| Before passing through filter | | — | 129 | 1.2 | 0.0 | 2.1 | 1.8 | 9.7 | 3.5 | 0.0 |
| Example 1 | After passing | Oxalic | 1.1 | 0.1 | 2.5 | 0.0 | 0.1 | 0.5 | 0.3 | 0.1 |
| | through 020GN | acid | | | | | | | | |
| | After passing | Oxalic | 0.4 | 0.0 | 0.0 | 0.0 | 0.2 | 0.1 | 0.2 | 0.1 |
| | through 40QSH | acid | | | | | | | | |
| Comparative | After passing | Pure | 2.7 | 0.9 | 35.0 | 1.0 | 0.2 | 1.2 | 1.5 | 15.0 |
| Example 1 | through 020GN | water | | | | | | | | |
| | After passing | Pure | 0.3 | 0.0 | 0.1 | 0.1 | 0.1 | 1.7 | 1.0 | 11.0 |
| | through 40QSH | water | | | | | | | | |

Although the case of washing the filter with pure water caused vanadium to be eluted from the filter and incorporated into the polymer solution by passing the polymer solution, the case of washing the filter with an aqueous oxalic acid solution caused almost no vanadium to be eluted from the filter, and also enabled the amounts of other metals to be decreased.

### Example 2

### (Production of Polymer)

The same procedure as in Example 1 was performed to polymerize p-hydroxystyrene and tert-butyl acrylate and purify the resultant, and finally the polymer concentration was prepared with acetone to 30% by mass.

### (Washing Depth Filter)

A depth filter manufactured by 3M, Zeta Plus 40QSH (90 mmφ) lot D, was mounted to a filter housing, pure water was sent by a pump to fill the housing, and the resultant was left to still stand for 30 minutes as it was. Thereafter, 85 g of an aqueous 3% by mass oxalic acid solution and subsequently 150 g of acetone were passed to wash the filter.

### (Passing Polymer Solution Through Depth Filter)

Two hundred g of a polymer solution having a concentration of 30% by mass was filtered once with the 40QSH lot D washed.

The metal content in the polymer was analyzed at each stage before a filter treatment and after a filter treatment, and the results were shown in Table 2.

### Comparative Example 2

The 40QSH filter was washed in the same manner as in Example 2 except that the aqueous oxalic acid solution was changed to pure water in washing the filter.

Two hundred g of the same polymer solution having a concentration of 30% by mass as that of Example 2 was filtered once with the 40QSH lot D washed.

The metal content in the polymer after the filter treatment was analyzed, and the results were shown in Table 2.

TABLE 2

| | | Filter | Metal content (resin weight basis; ppb) | | | | | | | |
|---|---|---|---|---|---|---|---|---|---|---|
| | | washing | Na | Mg | K | Ca | Cr | Fe | Ni | V |
| Before passing through filter | | — | 91 | 0.5 | 22 | 10 | 1.2 | 1.3 | 2.5 | 0.5 |
| Example 2 | After passing | Oxalic | 6.0 | 0.0 | 1.5 | 0.0 | 1.3 | 7.7 | 1.6 | 0.4 |
| | through 40QSH | acid | | | | | | | | |
| | (D) | | | | | | | | | |
| Comparative | After passing | Pure | 0.3 | 0.0 | 0.1 | 0.2 | 0.6 | 0.5 | 0.5 | 7.4 |
| Example 2 | through 40QSH | water | | | | | | | | |
| | (D) | | | | | | | | | |

### Example 3

### (Production of Polymer)

Equal molar amounts of 4-hydroxyphenyl methacrylate and tert-butyl acrylate were dissolved in a mixed solvent of PGME and methanol (mass ratio 70:30), and dimethyl 2,2-azobisisobutyrate was added thereto, to prepare a monomer solution.

A reaction container equipped with a stirrer, a condenser, and a thermometer was charged with a mixed solvent of PGME and methanol (mass ratio 70:30), the atmosphere was a nitrogen atmosphere, and then the temperature was raised to 80 °C under stirring. The monomer solution was dropped and supplied thereto at a constant rate over 4 hours, thereafter a polymerization reaction was continued for additional three hours, and the resultant was then cooled to room temperature. The polymer solution was analyzed by GC, and as a result, the monomer conversion was 99% or more.

Properties of the resulting polymer included 4-hydroxyphenyl methacrylate:tert-butyl acrylate=50:50, a weight average molecular weight (Mw) of 23,000, and a molecular weight distribution (Mw/Mn) of 2.4. The concentration of the resin solution was 27.4%.

### (Washing Depth Filter)

A depth filter manufactured by 3M, Zeta Plus 020GN lot B, was mounted to a filter housing, pure water was sent by a pump to fill the housing, and the resultant was left to still stand for 30 minutes as it was. Thereafter, 85 g of an aqueous 3% by mass oxalic acid solution and subsequently 150 g of acetone were passed to wash the filter.

### (Passing Polymer Solution Through Depth Filter)

Two hundred g of an unpurified polymer solution (polymer concentration 27.4% by mass) was filtered once with the 020GN lot B washed.

The content of vanadium in the polymer was analyzed before a filter treatment and after a filter treatment with a focus on vanadium elution from the filter, and the results were shown in Table 3.

### Comparative Example 3

The 020GN filter was washed in the same manner as in Example 3 except that the aqueous oxalic acid solution was changed to pure water in washing the filter.

Two hundred g of the same polymer solution as in Example 3 was filtered once with the 020GN lot B washed.

The content of vanadium in the polymer after the filter treatment was analyzed, and the result was shown in Table 3.

TABLE 3

| | | | Content of V |
|---|---|---|---|
| | | Filter | (resin weight |
| | | washing | basis; ppb) |
| Before passing through filter | | — | 0.0 |
| Example 3 | After passing | Oxalic acid | 0.3 |
| | through 020GN (B) | | |
| Comparative | After passing | Pure water | 4.7 |
| Example 3 | through 020GN (B) | | |

In a case where the filter washed with oxalic acid was used, incorporation of vanadium was kept at a low level even if a p-hydroxyphenyl methacrylate/tert-butyl acrylate copolymer solution was passed therethrough, but in a case where the filter washed with pure water was used, vanadium was largely eluted in passed the polymer solution therethrough, and as a result, largely incorporated into the polymer.

### Example 4

### (Production of Polymer)

The same procedure as in Example 1 was performed to polymerize p-hydroxystyrene and tert-butyl acrylate and purify the resultant, and finally the polymer concentration was prepared with acetone to 20% by mass.

### (Washing Depth Filter)

A depth filter manufactured by 3M, Zeta Plus 020GN lot B, was mounted to a filter housing, pure water was sent by a pump to fill the housing, and the resultant was left to still stand for 30 minutes as it was. Thereafter, 85 g of an aqueous 3% by mass oxalic acid solution and subsequently 150 g of acetone were passed to wash the filter.

### (Passing Polymer Solution Through Depth Filter)

Two hundred g of a polymer solution having a concentration of 20% by mass was filtered once with 020GN lot B washed.

The content of vanadium in the polymer was analyzed before a filter treatment and after a filter treatment with a focus on vanadium elution from the filter, and the results were shown in Table 4.

### Examples 5 to 6

The 020GN filter was washed in the same manner as in Example 4 except that the aqueous 3% by mass oxalic acid solution was changed to each of an aqueous 3% by mass citric acid solution and an aqueous 3% by mass 1,2,3,4-butanetetracarboxylic acid solution in washing the filter.

Two hundred g of the same polymer solution having a concentration of 20% by mass as in Example 4 was filtered once with the 020GN lot B washed.

The content of vanadium in the polymer after the filter treatment was analyzed, and the results were shown in Table 4.

### Comparative Example 4 to Comparative Example 7

The 020GN filter was washed in the same manner as in Example 4 except that the aqueous 3% by mass oxalic acid solution was changed to each of pure water, 3% by mass hydrochloric acid, an aqueous 3% by mass methanesulfonic acid solution, an aqueous 3% by mass acetic acid solution, and an aqueous 3% by mass citric acid solution in washing the filter.

Two hundred g of the same polymer solution having a concentration of 20% by mass as in Example 4 was filtered once with the washed 020GN lot B.

The content of vanadium in the polymer after the filter treatment was analyzed, and the results were shown in Table 4.

TABLE 4

| | | | Content of |
|---|---|---|---|
| | | | V (resin |
| | | | weight |
| | | Filter washing | basis; ppb) |
| Before passing through filter | | — | 0.0 |
| Example 4 | After passing | Oxalic acid | 0.7 |
| | through 020GN (B) | | |
| Example 5 | After passing | Citric acid | 0.4 |
| | through 020GN (B) | | |
| Example 6 | After passing | 1,2,3,4- | 0.2 |
| | through 020GN (B) | Butanetetracarboxylic | |
| | | acid | |
| Comparative | After passing | Pure water | 3.3 |
| Example 4 | through 020GN (B) | | |
| Comparative | After passing | Hydrochloric acid | 4.7 |
| Example 5 | through 020GN (B) | | |
| Comparative | After passing | MSA | 3.2 |
| Example 6 | through 020GN (B) | | |
| Comparative | After passing | Acetic acid | 4.9 |
| Example 7 | through 020GN (B) | | |

In a case where the filter washed with oxalic acid, citric acid, or 1,2,3,4-butanetetracarboxylic acid was used, incorporation of vanadium was kept at a low level even if a p-hydroxystyrene/tert-butyl acrylate copolymer solution was passed therethrough, but in a case where the filter washed with pure water, hydrochloric acid, methanesulfonic acid, or acetic acid was used, vanadium was largely eluted in passing the polymer solution therethrough, and as a result, largely incorporated into the polymer.

1. A method for producing a polymer, the method comprising:
a step of preparing a polymer; and
a step of passing a polymer solution, in which the polymer is dissolved in an organic solvent, through a depth filter, wherein
the depth filter has been washed with a solution containing an acid having a plurality of carboxyl groups.

2. The method for producing a polymer according to claim 1, wherein the polymer comprises a structural unit having an acidic group.

3. The method for producing a polymer according to claim 2, wherein the acidic group comprises at least one selected from the group consisting of a phenolic hydroxyl group, a carboxyl group, and a sulfo group.

4. The method for producing a polymer according to claim 1, wherein the acid having a plurality of carboxyl groups is a divalent to tetravalent carboxylic acid.

5. The method for producing a polymer according to claim 1, wherein the acid having a plurality of carboxyl groups comprises at least one selected from the group consisting of oxalic acid, malonic acid, succinic acid, citric acid, 1,2,3,4-butanetetracarboxylic acid and ethylenediaminetetraacetic acid.

6. The method for producing a polymer according to claim 1, wherein the depth filter comprises at least one selected from the group consisting of diatomaceous earth, magnesia, pearlite, talc, colloidal silica, activated carbon, zeolite, clay, and cellulose.

7. The method for producing a polymer according to claim 1, wherein the depth filter comprises at least one selected from the group consisting of diatomaceous earth, magnesia, pearlite, talc, colloidal silica, activated carbon, zeolite, clay, and cellulose, and a cation charge control agent that generates zeta potential and/or an ion exchanger excluding a Na-type ion exchanger.

8. The method for producing a polymer according to claim 1, wherein
the acid having a plurality of carboxyl groups is a divalent to tetravalent carboxylic acid, and
the depth filter comprises at least one selected from the group consisting of diatomaceous earth, magnesia, pearlite, talc, colloidal silica, activated carbon, zeolite, clay, and cellulose.

9. The method for producing a polymer according to claim 1, wherein
the acid having a plurality of carboxyl groups is a divalent to tetravalent carboxylic acid, and
the depth filter comprises at least one selected from the group consisting of diatomaceous earth, magnesia, pearlite, talc, colloidal silica, activated carbon, zeolite, clay, and cellulose, and a cation charge control agent that generates zeta potential and/or an ion exchanger excluding a Na-type ion exchanger.

10. A method for producing a polymer, the method comprising:
a step of preparing a polymer;
a step of installing a depth filter in filtration equipment, thereafter washing the depth filter with a solution containing an acid having a plurality of carboxyl groups, and subsequently washing the depth filter with water and/or an organic solvent; and
a step of passing a polymer solution in which the polymer is dissolved in an organic solvent, through the washed depth filter.

11. The method for producing a polymer according to claim 10, wherein the polymer comprises a structural unit having an acidic group.

12. The method for producing a polymer according to claim 11, wherein the acidic group comprises at least one selected from the group consisting of a phenolic hydroxyl group, a carboxyl group, and a sulfo group.

13. The method for producing a polymer according to claim 10, wherein the acid having a plurality of carboxyl groups is a divalent to tetravalent carboxylic acid.

14. The method for producing a polymer according to claim 10, wherein
the acid having a plurality of carboxyl groups is a divalent to tetravalent carboxylic acid, and
the depth filter comprises at least one selected from the group consisting of diatomaceous earth, magnesia, pearlite, talc, colloidal silica, activated carbon, zeolite, clay, and cellulose.

15. The method for producing a polymer according to claim 10, wherein
the acid having a plurality of carboxyl groups is a divalent to tetravalent carboxylic acid, and
the depth filter comprises at least one selected from the group consisting of diatomaceous earth, magnesia, pearlite, talc, colloidal silica, activated carbon, zeolite, clay, and cellulose, and a cation charge control agent that generates zeta potential and/or an ion exchanger excluding a Na-type ion exchanger.
